(19) United States
(12) Patent Application Publication
(10) Pub. No.: US 2025/0213417 A1
(43) Pub. Date: Jul. 3, 2025

(54) CONTROL METHOD FOR REDUCING POWER CONSUMPTION OF WEARABLE DEVICE, AND WEARABLE DEVICE PERFORMING SAME

(71) Applicant: Samsung Electronics Co., Ltd., Suwon-si (KR)

(72) Inventors: Gigun NAM, Suwon-si (KR); Youngwoo CHO, Suwon-si (KR)

(21) Appl. No.: 19/086,617

(22) Filed: Mar. 21, 2025

Related U.S. Application Data
(63) Continuation of application No. PCT/KR2023/014967, filed on Sep. 27, 2023.

(30) Foreign Application Priority Data
Oct. 20, 2022 (KR) 10-2022-0135816

(51) Int. Cl. A61H 3/00; A61H 1/02

(52) U.S. Cl. CPC A61H 3/00; A61H 1/0244; A61H 1/0281; A61H 2003/007; A61H 2201/1215; A61H 2201/5007; A61H 2201/5061

(57) ABSTRACT

A control method for reducing power consumption of a wearable device, and/or a wearable device performing the same. The wearable device may include: a driving module that uses a motor and a motor driver circuit to generate torque applied to a user's body; a waist support frame for supporting the user's body when the wearable device is worn on the user's body; a leg driving frame for transmitting the torque generated by a driving module to the user's body; a back electromotive force control circuit for monitoring a back electromotive force that may be generated by the operation of the motor, and for limiting the voltage level of the back electromotive force below a reference level; and a processor for controlling the operation of the driving module and controlling supply of power to the back electromotive force control circuit.

### CROSS-REFERENCE TO RELATED APPLICATIONS

This application is a continuation application of International Application No. PCT/KR2023/014967 designating the United States, filed on Sep. 27, 2023, in the Korean Intellectual Property Receiving Office and claiming priority to Korean Patent Application No. 10-2022-0135816, filed on Oct. 20, 2022, the disclosures of which are all hereby incorporated by reference herein in their entireties.

### BACKGROUND

### Technical Field

Certain example embodiments may relate to a control method for reducing the power consumption of a wearable device and/or a wearable device performing the same.

### Description of Related Art

A walking assistance device may refer to a machine or a device that helps a patient who for example is unable to walk on their own because of diseases, accidents, or other causes with their walking exercises for rehabilitation treatment, and/or to a machine or device that helps a person exercise such as walk. In our current, rapidly aging society, a growing number of people experience inconvenience when walking or have difficulty with normal walking due to malfunctioning joints, and there is increasing interest in walking assistance devices. A walking assistance device may be worn on a user's body to assist the user in walking by providing muscular strength and to induce the user to walk in a normal walking pattern.

### SUMMARY

A wearable device according to an example embodiment may include a driving module configured to generate torque applied to the body of a user using a motor and a motor driver circuit, a waist support frame configured to support the body of the user when the wearable device is worn on the body of the user, a leg driving frame configured to relay the generated torque to the body of the user, a back electromotive force control circuit configured to monitor a back electromotive force that may be generated according to an operation of the motor and limit a voltage level of the back electromotive force to a reference level or lower, and a processor configured to control an operation of the driving module and control the power supply to the back electromotive force control circuit.

A method according to an example embodiment of controlling a back electromotive force control circuit of a wearable device, which includes a motor, a motor driver circuit configured to control the motor, and a back electromotive force control circuit configured to monitor a back electromotive force that may be generated according to an operation of the motor and limit a voltage level of the back electromotive force to a reference level or lower, may include determining whether a driving command for using the wearable device is received from an electronic device linked with the wearable device, determining whether power is being supplied to the motor driver circuit and the motor in a state in which the driving command is not received, and controlling the power supply to the back electromotive force control circuit based on whether power is supplied to the motor driver circuit and whether power is supplied to the motor.

A method according to an example embodiment of controlling a back electromotive force control circuit of a wearable device, which includes a motor, a motor driver circuit configured to control the motor, a leg driving frame configured to relay torque generated by the motor to a body of a user, and a back electromotive force control circuit configured to monitor a back electromotive force that may be generated according to an operation of the motor and limit a voltage level of the back electromotive force to a reference level or lower, may include detecting whether there is a movement of the motor, determining whether a motor rotation sensor configured to detect the rotation of the motor around a rotor of the motor and an angle sensor configured to measure an angle of the leg driving frame are operating when a movement of the motor is detected, and determining whether to block the power supply to the back electromotive force control circuit based on whether the motor rotation sensor or the angle sensor is operating.

### BRIEF DESCRIPTION OF DRAWINGS

The above and other aspects, features, and advantages of certain example embodiments of the present disclosure will be more apparent from the following detailed description, taken in conjunction with the accompanying drawings, in which:

FIG. 1 is a diagram illustrating an overview of a wearable device worn on a user's body according to an example embodiment;

FIG. 2 is a diagram illustrating an exercise management system including a wearable device and an electronic device, according to an example embodiment;

FIG. 3 is a rear schematic diagram illustrating a wearable device according to an example embodiment;

FIG. 4 is a left side view of a wearable device according to an example embodiment;

FIGS. 5A and 5B are diagrams illustrating a configuration of a control system of a wearable device according to an example embodiment;

FIG. 6 is a diagram illustrating an interaction between a wearable device and an electronic device, according to an example embodiment;

FIG. 7 is a diagram illustrating a configuration of an electronic device according to an example embodiment;

FIG. 8 is a flowchart illustrating a method of controlling a back electromotive force control circuit of a wearable device, according to an example embodiment;

FIG. 9 is a flowchart illustrating a method of controlling a back electromotive force control circuit of a wearable device, according to an example embodiment; and

FIG. 10 is a diagram illustrating a wearable device worn on a user's upper arm, according to an example embodiment.

### DETAILED DESCRIPTION

The following detailed structural or functional description is provided as an example only and various alterations and modifications may be made to embodiments. Accordingly, the embodiments are not construed as limited to the disclosure and should be understood to include all changes, equivalents, and replacements within the idea and the technical scope of the disclosure.

As used herein, the singular forms “a”, “an”, and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments will be described in detail with reference to the accompanying drawings. When describing the examples with reference to the accompanying drawings, like reference numerals refer to like elements and a repeated description related thereto will be omitted.

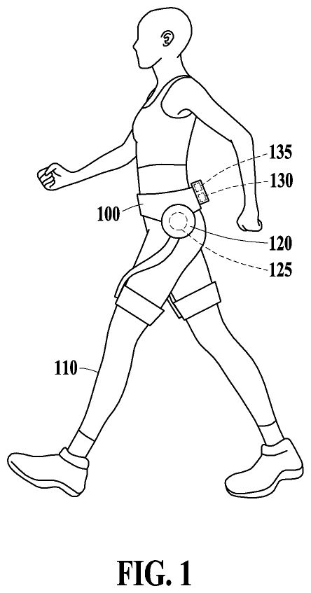

FIG. 1 is a diagram illustrating an overview of a wearable device worn on a user's body, according to an embodiment.

Referring to FIG. 1, in an embodiment, a wearable device 100 may be a device worn on a body of a user 110 to assist the user 110 in walking, exercising, and/or working. In an embodiment, the wearable device 100 may be used to measure a physical ability (e.g., a walking ability, an exercise ability, or an exercise posture) of the user 110. In embodiments, the term “wearable device” may be replaced with “wearable robot,” “walking assistance device,” or “exercise assistance device”. The user 110 may be a human or an animal, but is not limited thereto. The wearable device 100 may be worn on a body (e.g., a lower body (the legs, ankles, knees, etc.), an upper body (the torso, arms, wrists, etc.), or the waist) of the user 110 to apply an external force such as an assistance force and/or a resistance force to a body motion of the user 110. The assistance force may be a force applied in the same direction as the body motion direction of the user 110, the force to assist a body motion of the user 110. The resistance force may be a force impeding the body motion of the user 110, which is applied in an opposite direction to the direction of the body motion of the user 110. The term “resistance force” may also be referred to as an “exercise load”.

In an embodiment, the wearable device 100 may operate in a walking assistance mode to assist the user 110 in walking. In the walking assistance mode, the wearable device 100 may assist the walking of the user 110 by applying an assistance force generated through a driving module 120 of the wearable device 100 to the body of the user 110. The wearable device 100 may enable the user 110 to walk independently or to walk for a long time by providing a force required for the user 110 to walk, thereby expanding the walking ability of the user 110. The wearable device 100 may also improve the walking of a user having an abnormal walking habit or posture.

In an embodiment, the wearable device 100 may operate in an exercise assistance mode to enhance the effect of an exercise on the user 110. In the exercise assistance mode, the wearable device 100 may impede the body motion of the user 110 or resist the body motion of the user 110 by applying a resistance force generated by the driving module 120 of the wearable device 100 to the body of the user 110. When the wearable device 100 is a hip-type wearable device that is worn on the waist (or pelvis) and legs (e.g., thighs) of the user 110, the wearable device 100 may provide an exercise load to a leg motion of the user 110 while being worn on the legs, thereby enhancing the exercise effect on the legs of the user 110. In an embodiment, the wearable device 100 may apply an assistance force to the body of the user 110 to assist the user 110 in exercising. For example, when a person with a disability or an elderly person wants to exercise by wearing the wearable device 100, the wearable device 100 may provide an assistance force to assist a body motion during an exercise process. In an embodiment, the wearable device 100 may provide an assistance force and a resistance force in combination for each exercise section or time section, for example, providing an assistance force in some exercise sections and a resistance force in other exercise sections.

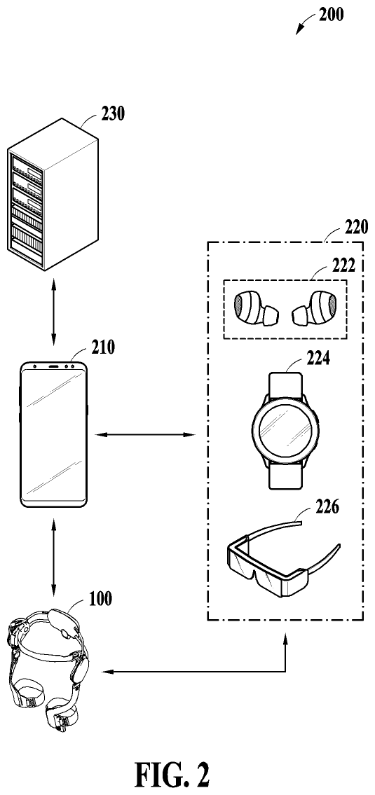

In an embodiment, the wearable device 100 may operate in a physical ability measurement mode for measuring a physical ability of the user 110. The wearable device 100 may measure motion information of a user using one or more sensors (e.g., an angle sensor 125 and an inertial measurement unit (IMU) 135) provided in the wearable device 100 while the user performs walking or exercise, and the wearable device 100 or an electronic device (e.g., an electronic device 210 of FIG. 2) interworking with the wearable device 100 may evaluate a physical ability of the user based on the measured motion information. For example, a gait index or an exercise ability indicator (e.g., muscular strength, endurance, balance, or exercise posture) of the user 110 may be estimated through the motion information of the user 110 measured by the wearable device 100. The physical ability measurement mode may include an exercise posture evaluation mode for evaluating the exercise posture of the user while the user performs exercise.

In embodiments of the present disclosure, for ease of description, the wearable device 100 is described as an example of a hip-type wearable device, as illustrated in FIG. 1, but the embodiments are not limited thereto. As described above, the wearable device 100 may be worn on body parts (e.g., upper arms, lower arms, hands, calves, and feet) other than the waist and legs (particularly, the thighs), and a shape and configuration of the wearable device 100 may vary depending on the body part on which the wearable device 100 is worn.

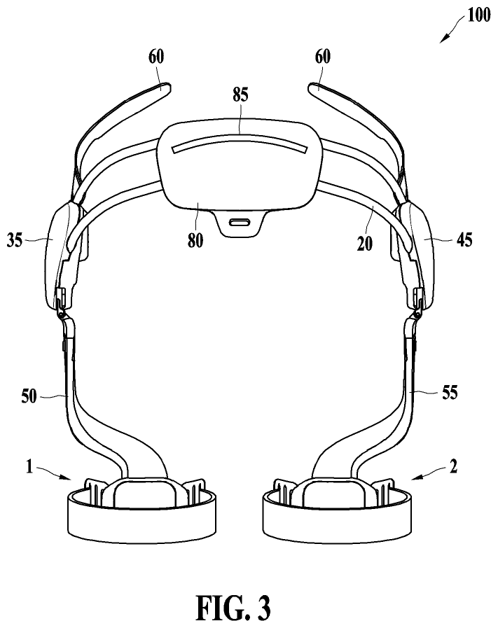

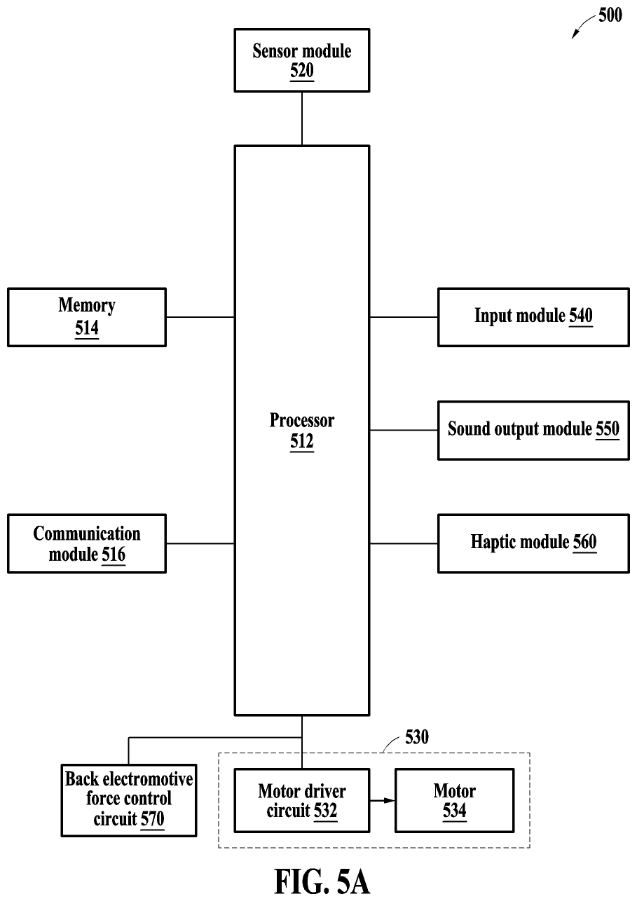

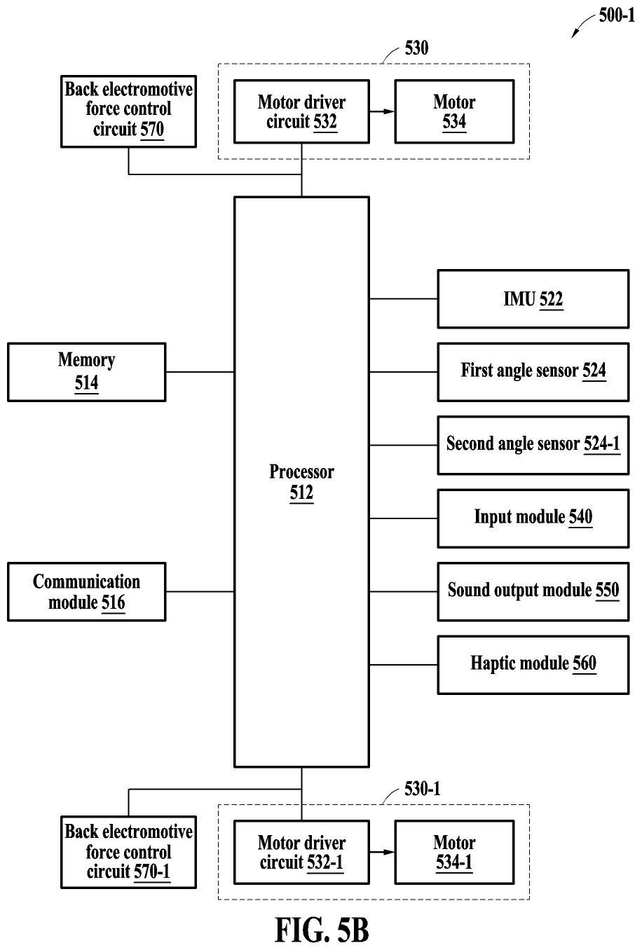

According to an embodiment, the wearable device 100 may include a support frame (e.g., a waist support frame 20) for supporting the body of the user 110 when the wearable device 100 is worn on the body of the user 110, the driving module 120 (e.g., driving modules 35 and 45 of FIG. 3) for generating torque applied to the legs of the user 110, a leg driving frame (e.g., leg driving frames 50 and 55 of FIG. 3) for relaying the torque generated by the driving module 120 to the legs of the user 110, a sensor module (e.g., a sensor module 520 of FIG. 5A) including one or more sensors for obtaining sensor data including motion information on the body motion (e.g., leg motion or upper body motion) of the user 110, and a processor 130 for controlling the operation of the wearable device 100.

The sensor module may include the angle sensor 125 and the IMU 135. The angle sensor 125 may measure a rotation angle of the leg driving frame of the wearable device 100 corresponding to a hip joint angle value of the user 110. The rotation angle of the leg driving frame measured by the angle sensor 125 may be estimated as the hip joint angle value (or a leg angle value) of the user 110. The angle sensor 125 may include, for example, an encoder and/or a hall sensor. In an embodiment, the angle sensor 125 may be disposed adjacent to a position where a motor included in the driving module 120 is connected, directly or indirectly, to the leg driving frame. The IMU 135 may include an acceleration sensor and/or an angular velocity sensor, and may measure a change in acceleration and/or angular velocity according to a motion of the user 110. The IMU 135 may measure a motion value of a base body (e.g., a base body 80 of FIG. 3) or the waist support frame of the wearable device 100, for example. The motion value of the base body or the waist support frame measured by the IMU 135 may be estimated as an upper body motion value of the user 110.

In an embodiment, the processor 130 and the IMU 135 may be arranged within the base body (e.g., the base body 80 of FIG. 3) of the wearable device 100. The base body may be disposed on a lumbar region (an area of the lower back) of the user 110 while the user 110 is wearing the wearable device 100. The base body may be formed on or attached to the outside of the waist support frame of the wearable device 100. The base body may be mounted on the lumbar region of the user 110 to provide a cushioning feeling to the lower back of the user 110 and may support the lower back of the user 110 together with the waist support frame. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

FIG. 2 is a diagram illustrating an exercise management system including a wearable device and an electronic device, according to an embodiment.

Referring to FIG. 2, an exercise management system 200 may include the wearable device 100, the electronic device 210, other wearable devices 220, and a server 230. In an embodiment, at least one (e.g., the other wearable devices 220 or the server 230) of the above-described devices may be omitted from the exercise management system 200, or one or more other devices (e.g., an exclusive controller device of the wearable device 100) may be added to the exercise management system 200.

In an embodiment, the wearable device 100 may be worn on a body of a user in a walking assistance mode to assist a motion of the user. For example, the wearable device 100 may be worn on the legs of the user to help the user in walking by generating an assistance force for assisting a leg motion of the user.

In an embodiment, to enhance the effect of the user's exercise in an exercise assistance mode, the wearable device 100 may generate a resistance force to impede the body motion of the user or an assistance force to assist the body motion of the user and may apply such a force to the body of the user. In the exercise assistance mode, through the electronic device 210, the user may select an exercise program (e.g., squat, split lunge, dumbbell squat, lunge and knee up, stretching, etc.) that the user desires to conduct using the wearable device 100 and/or an exercise intensity to be applied to the wearable device 100. The wearable device 100 may control a driving module of the wearable device 100 according to the exercise program selected by the user and obtain sensor data including motion information of the user through a sensor module. The wearable device 100 may adjust the strength of the resistance force or assistance force applied to the user according to the exercise intensity selected by the user. For example, the wearable device 100 may control the driving module to generate a resistance force corresponding to the exercise intensity selected by the user.

In an embodiment, the wearable device 100 may be used to measure a physical ability of the user by interworking with the electronic device 210. The wearable device 100 may operate in a physical ability measurement mode, which is a mode for measuring the physical ability of the user under the control of the electronic device 210, and may transmit sensor data obtained by the motion of the user in the physical ability measurement mode to the electronic device 210. The electronic device 210 may evaluate the physical ability of the user by analyzing the sensor data received from the wearable device 100.

The electronic device 210 may communicate with the wearable device 100 and remotely control the wearable device 100 or provide the user with state information on a state (e.g., a booting state, a charging state, a sensing state, or an error state) of the wearable device 100. The electronic device 210 may receive the sensor data obtained by the sensor module of the wearable device 100 from the wearable device 100, and estimate an exercise result or the physical ability of the user based on the received sensor data. The electronic device 210 may provide the user with the exercise result or physical ability of the user through a graphical user interface (GUI).

In an embodiment, the user may execute a program (e.g., an application) in the electronic device 210 to control the wearable device 100 and may adjust an operation or a set value (e.g., a torque intensity output from the driving module (e.g., the driving modules 35 and 45 of FIG. 3), the volume of audio output from a sound output module (e.g., a sound output module 550 of FIGS. 5A and 5B), and the brightness of a lighting unit (e.g., a lighting unit 85 of FIG. 3)) of the wearable device 100 through the program. The program executed by the electronic device 210 may provide a GUI for interaction with the user. The electronic device 210 may be a device in various forms. For example, the electronic device 210 may include a portable communication device (e.g., a smartphone), a computer device, an access point, a portable multimedia device, or a home appliance (e.g., a television, an audio device, or a projector device), but examples are not limited to the foregoing devices.

In an embodiment, the electronic device 210 may be connected to the server 230 using short-range wireless communication or cellular communication. The server 230 may receive user profile information of the user of the wearable device 100 from the electronic device 210 and store and manage the received user profile information. The user profile information may include, for example, information about at least one of a name, age, gender, height, weight, or body mass index (BMI). The server 230 may receive exercise history information about an exercise performed by the user from the electronic device 210 and store and manage the received exercise history information. The server 230 may provide the electronic device 210 with various exercise programs or physical ability measurement programs to be provided to the user.

In an embodiment, the wearable device 100 and/or the electronic device 210 may be connected to the other wearable devices 220. The other wearable devices 220 may include, for example, wireless earphones 222, a smartwatch 224, or smart glasses 226, but examples are not limited to the foregoing devices. In an embodiment, the smartwatch 224 may measure a biosignal including heart rate information of the user, and may transmit the measured biosignal to the electronic device 210 and/or the wearable device 100. The electronic device 210 may estimate the heart rate information (e.g., a current heart rate, a maximum heart rate, or an average heart rate) of the user based on the biosignal received from the smartwatch 224 and provide the estimated heart rate information to the user.

In an embodiment, the exercise result information, physical ability information, and/or exercise posture evaluation information of the user that are determined by the electronic device 210 may be transmitted to the other wearable devices 220 and provided to the user through the other wearable devices 220. The state information of the wearable device 100 may be transmitted to the other wearable devices 220 and provided to the user through the other wearable devices 220. In an embodiment, the wearable device 100, the electronic device 210, and the other wearable devices 220 may be connected to one another through wireless communication (e.g., Bluetooth™ or Wi-Fi communication).

In an embodiment, the wearable device 100 may provide (or output) feedback (e.g., visual, auditory, or haptic feedback) corresponding to a state of the wearable device 100 according to a control signal received from the electronic device 210. For example, the wearable device 100 may provide visual feedback through the lighting unit (e.g., the lighting unit 85 of FIG. 3) and provide auditory feedback through the sound output module (e.g., the sound output module 550 of FIGS. 5A and 5B). The wearable device 100 may include a haptic module (e.g., a haptic module 560 of FIGS. 5A and 5B) and provide haptic feedback in the form of vibration to the body of the user through the haptic module. The electronic device 210 may also provide (or output) feedback (e.g., visual, auditory, or haptic feedback) corresponding to the state of the wearable device 100.

In an embodiment, the electronic device 210 may present a personalized exercise goal to the user in the exercise assistance mode. The personalized exercise goal may include respective target amounts of exercise for exercise types (e.g., strength exercise, balance exercise, and aerobic exercise) desired by the user, determined by the electronic device 210 and/or the server 230. When the server 230 determines a target amount of exercise, the server 230 may transmit information about the determined target amount of exercise to the electronic device 210. The electronic device 210 may personalize and present the target amounts of exercise for the exercise types, such as strength exercise, aerobic exercise, and balance exercise, according to a desired exercise program (e.g., squat, split lunge, or a lunge and knee up) and/or physical characteristics (e.g., the age, height, weight, and BMI) of the user. The electronic device 210 may display a GUI screen displaying the target amounts of exercise for the respective exercise types on a display.

In an embodiment, the electronic device 210 and/or the server 230 may include a database in which information about a plurality of exercise programs to be provided to the user through the wearable device 100 is stored. To achieve an exercise goal of the user, the electronic device 210 and/or the server 230 may recommend an exercise program suitable for the user. The exercise goal may include, for example, at least one of muscle strength improvement, physical strength improvement, cardiovascular endurance improvement, core stability improvement, flexibility improvement, or symmetry improvement. The electronic device 210 and/or the server 230 may store and manage the exercise program performed by the user, the results of performing the exercise program, and the like.

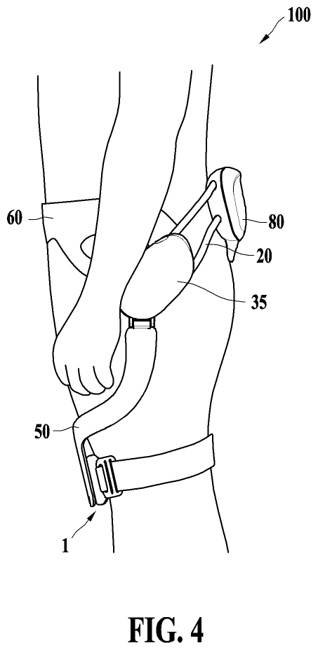

FIG. 3 is a rear schematic diagram illustrating a wearable device according to an embodiment. FIG. 4 is a left side view of a wearable device according to an embodiment.

Referring to FIGS. 3 and 4, the wearable device 100 may include the base body 80, the waist support frame 20, the driving modules 35 and 45, the leg driving frames 50 and 55, thigh fastening portions 1 and 2, and a waist fastening portion 60. The base body 80 may include a lighting unit 85. In an embodiment, at least one (e.g., the lighting unit 85) of the components described above may be omitted from the wearable device 100 or one or more other components may be added to the wearable device 100.

The base body 80 may be disposed on a lumbar region of a user while the user is wearing the wearable device 100. The base body 80 may be mounted on the lumbar region of the user to provide a cushioning feeling to the lower back of the user and may support the lower back of the user. The base body 80 may be hung on a hip region (an area of the hips) of the user such that the wearable device 100 may not deviate downward due to gravity while the user is wearing the wearable device 100. The base body 80 may distribute a portion of the weight of the wearable device 100 to the lower back of the user while the user is wearing the wearable device 100. The base body 80 may be connected to the waist support frame 20. Waist support frame connection elements (not shown) which may be connected to the waist support frame 20 may be provided at both ends of the base body 80.

In an embodiment, the lighting unit 85 may be provided on an outer surface of the base body 80. The lighting unit 85 may include a light source (e.g., light emitting diode (LED)). The lighting unit 85 may emit light by control of a processor (not shown) (e.g., a processor 512 of FIGS. 5A and 5B). According to embodiments, the processor may control the lighting unit 85 to provide (or output) visual feedback corresponding to the state of the wearable device 100.

The waist support frame 20 may support the body (e.g., the waist) of the user when the wearable device 100 is worn on the body of the user. The waist support frame 20 may extend from both ends of the base body 80. The lumbar region of the user may be accommodated inside the waist support frame 20. The waist support frame 20 may include at least one rigid body beam. Each beam may be in a curved shape having a preset curvature to enclose the lumbar region of the user. The waist fastening portion 60 may be connected, directly or indirectly, to an end portion of the waist support frame 20. The driving modules 35 and 45 may be connected to the waist support frame 20.

In an embodiment, the processor comprising processing circuitry, a memory, an IMU (e.g., the IMU 135 of FIG. 1 or an IMU 522 of FIG. 5B), a communication module (e.g., a communication module 516 of FIGS. 5A and 5B), a sound output module (e.g., the sound output module 550 of FIGS. 5A and 5B) and a battery (not shown) may be disposed inside the base body 80. The base body 80 may protect the components disposed therein. The processor may generate a control signal for controlling an operation of the wearable device 100. The processor may control an actuator of the driving modules 35 and 45. The processor and the memory may be included in a control circuit. The control circuit may further include a power supply circuit configured to supply power from the battery to each of the components of the wearable device 100.

In an embodiment, the wearable device 100 may include a sensor module (not shown) (e.g., the sensor module 520 of FIG. 5A) configured to obtain sensor data from one or more sensors. The sensor module may obtain sensor data including motion information of the user and/or motion information of the components of the wearable device 100. The sensor module may include, for example, the IMU (e.g., the IMU 135 of FIG. 1 or the IMU 522 of FIG. 5B) for measuring an upper body motion value of the user or a motion value of the waist support frame 20 and an angle sensor (e.g., the angle sensor 125 of FIG. 1, a first angle sensor 524 and a second angle sensor 524-1 of FIG. 5B) for measuring a hip joint angle value of the user or a motion value of the leg driving frames 50 and 55, but is not limited thereto. For example, the sensor module may further include at least one of a position sensor, a temperature sensor, a biosignal sensor, or a proximity sensor.

The waist fastening portion 60 may be connected to the waist support frame 20 to fasten the waist support frame 20 to the waist of the user. The waist fastening portion 60 may include, for example, a pair of belts.

The driving modules 35 and 45 may generate an external force (or torque) applied to the body of the user based on the control signal generated by the processor. For example, the driving modules 35 and 45 may generate an assistance force or a resistance force applied to the legs of the user. In an embodiment, the driving modules 35 and 45 may include a first driving module 45 disposed in a position corresponding to a position of the right hip joint of the user, and a second driving module 35 disposed in a position corresponding to a position of the left hip joint of the user. The first driving module 45 may include a first actuator and a first joint member, and the second driving module 35 may include a second actuator and a second joint member. The first actuator may provide power to be relayed to the first joint member, and the second actuator may provide power to be relayed to the second joint member. The first actuator and the second actuator may respectively include motors (motors 534 and 534-1 of FIG. 5B) for generating power (or torque) by receiving power from the battery. When the motor receives power and is driven, the motor may generate a force (an assistance force) for assisting a body motion of the user or a force (a resistance force) for impeding a body motion of the user. In an embodiment, the control module may adjust the intensity or direction of a force generated by the motor by adjusting a voltage or a current supplied to the motor.

In an embodiment, the first joint member and the second joint member may receive power respectively from the first actuator and the second actuator and may apply an external force to the body of the user based on the received power. The first joint member and the second joint member may respectively be arranged at positions corresponding to the joints of the user. One side of the first joint member may be connected to the first actuator, and the other side of the first joint member may be connected to the first leg driving frame 55. The first joint member may rotate by the power relayed from the first actuator. An encoder or a hall sensor that may operate as an angle sensor to measure a rotation angle (corresponding to a joint angle of the user) of the first joint member or the first leg driving frame 55 may be disposed on a side of the first joint member. One side of the second joint member may be connected to the second actuator, and the other side of the second joint member may be connected to the second leg driving frame 50. The second joint member may rotate by the power relayed from the second actuator. An encoder or a hall sensor that may operate as an angle sensor to measure a rotation angle of the second joint member or the second leg driving frame 50 may be disposed on a side of the second joint member.

In an embodiment, the first actuator may be arranged in a lateral direction of the first joint member, and the second actuator may be arranged in a lateral direction of the second joint member. A rotation axis of the first actuator and a rotation axis of the first joint member may be spaced apart from each other, and a rotation axis of the second actuator and a rotation axis of the second joint member may also be spaced apart from each other. However, examples are not limited to the foregoing examples, and an actuator and a joint member may share a rotation axis. In an embodiment, each actuator may be spaced apart from a corresponding joint member. In this case, the driving modules 35 and 45 may further include a power transmission module (not shown) for relaying power from the actuators to the joint members. The power transmission module may be a rotary body, such as a gear, or a longitudinal member, such as a wire, a cable, a string, a spring, a belt, or a chain. However, the scope of the embodiment is not limited by the positional relationship between an actuator and a joint member and the power transmission structure described above.

In an embodiment, the leg driving frames 50 and 55 may relay torque generated by the driving modules 35 and 45 to the body (e.g., the thighs) of the user when the wearable device 100 is worn on the user's legs. The relayed torque may function as an external force applied to the motion of the user's legs. As one end portion of the leg driving frames 50 and 55 is connected to a joint member to rotate and the other end portion of the leg driving frames 50 and 55 is connected to the thigh fastening portions 1 and 2, the leg driving frames 50 and 55 may relay the torque generated by the driving modules 35 and 45 to the thighs of the user while supporting the thighs of the user. For example, the leg driving frames 50 and 55 may push or pull the user's thighs. The leg driving frames 50 and 55 may extend in a longitudinal direction of the user's thighs. The leg driving frames 50 and 55 may be folded to wrap around at least a portion of the user's thigh circumference. The leg driving frames 50 and 55 may include the first leg driving frame 55 configured to relay torque to the right leg of the user, and the second leg driving frame 50 configured to relay torque to the left leg of the user.

The thigh fastening portions 1 and 2 may be connected to the leg driving frames 50 and 55 and may fasten the wearable device 100 to the thighs of the user. For example, the thigh fastening portions 1 and 2 may include the first thigh fastening portion 2 configured to fasten the wearable device 100 to the right thigh of the user and the second thigh fastening portion 1 configured to fasten the wearable device 100 to the left thigh of the user.

In an embodiment, the first thigh fastening portion 2 may include a first cover, a first fastening frame, and a first strap, and the second thigh fastening portion 1 may include a second cover, a second fastening frame, and a second strap. The first cover and the second cover may apply torque generated by the driving modules 35 and 45 to the thighs of the user. The first cover and the second cover may be disposed on respective sides of the thighs of the user to push or pull the thighs of the user. For example, the first cover and the second cover may be arranged on the front surfaces of the thighs of the user. The first cover and the second cover may be arranged in circumferential directions of the thighs of the user. The first cover and the second cover may extend to both sides from the other end portions of the leg driving frames 50 and 55 and may include curved surfaces corresponding to the thighs of the user. One end of the first cover and the second cover may be connected to the fastening frames, and the other ends thereof may be connected to the straps.

The first fastening frame and the second fastening frame may be arranged, for example, to surround at least some portions of the circumferences of the thighs of the user such that the thighs of the user may not be separated from the wearable device 100. The first fastening frame may have a fastening structure that connects the first cover to the first strap, and the second fastening frame may have a fastening structure that connects the second cover to the second strap.

The first strap may enclose the remaining portion of the circumference of the right thigh of the user that is not covered by the first cover and the first fastening frame, and the second strap may enclose the remaining portion of the circumference of the left thigh of the user that is not covered by the second cover and the second fastening frame. The first strap and the second strap may include, for example, an elastic material (e.g., a band).

FIGS. 5A and 5B are diagrams illustrating a configuration of a control system of a wearable device according to an embodiment.

Referring to FIG. 5A, the wearable device 100 may be controlled by a control system 500. The control system 500 may include the processor 512 (e.g., the processor 130), a memory 514, the communication module 516, the sensor module 520, a driving module 530, an input module 540, the sound output module 550, a haptic module 560, and a back electromotive force control circuit 570. In an embodiment, at least one (e.g., the sound output module 550 or the haptic module 560) of the above-described components may be omitted from the control system 500, or one or more other components may be added to the control system 500.

The driving module 530 may include a motor 534 configured to generate torque (or power), and a motor driver circuit 532 configured to control the motor 534. Although FIG. 5A illustrates the driving module 530 including one motor driver circuit 532 and one motor 534, the example of FIG. 5A is merely an example. Referring to FIG. 5B, a control system 500-1 may include two or more (e.g., three or more) motor driver circuits 532 and 532-1 and motors 534 and 534-1. The driving module 530 including the motor driver circuit 532 and the motor 534 may correspond to the first driving module 45 of FIG. 3, and a driving module 530-1 including the motor driver circuit 532-1 and the motor 534-1 may correspond to the second driving module 35 of FIG. 3. The following descriptions of the motor driver circuit 532 and the motor 534 may also be respectively applicable to the motor driver circuit 532-1 and the motor 534-1 illustrated in FIG. 5B.

Referring back to FIG. 5A, the sensor module 520 may include a sensor circuit including at least one sensor. The sensor module 520 may include sensor data including motion information of components (e.g., the waist support frame 20, the base body 80, and the leg driving frames 50 and 55) of the wearable device 100. In an embodiment, the motion information of a component of the wearable device 100 may correspond to body motion information of a user. The sensor module 520 may transmit obtained sensor data to the processor 512 or store the obtained sensor data in a separate storage module (not shown) including the memory 514. The sensor module 520 may include the IMU 522 and an angle sensor (e.g., the first angle sensor 524 and the second angle sensor 524-1) as illustrated in FIG. 5B. The IMU 522 (e.g., the IMU 135) may measure an upper body motion value of a user wearing the wearable device 100. For example, the IMU 522 may sense the acceleration and angular velocity of an X-axis, a Y-axis, and a Z-axis according to a motion of the user. The IMU 522 may be used to measure, for example, at least one of a forward and backward tilt, a left and right tilt, or a rotation of the body of the user. In an embodiment, the IMU 522 may obtain motion values (e.g., acceleration values and angular velocity values) of a waist support frame (e.g., the waist support frame 20 of FIG. 3) or a base body (e.g., the base body 80 of FIG. 3) of the wearable device 100. The motion values of the waist support frame or the base body may correspond to upper body motion values of the user.

The angle sensor (e.g., the angle sensor 125) may measure a hip joint angle value according to a leg motion of the user. Sensor data that may be measured by the angle sensor may include, for example, a hip joint angle value of the right leg, a hip joint angle value of the left leg, and information on a motion direction of a leg. For example, the first angle sensor 524 of FIG. 5B may obtain the hip joint angle value of the right leg of the user, and the second angle sensor 524-1 may obtain the hip joint angle value of the left leg of the user. The first angle sensor 524 and the second angle sensor 524-1 may each include, for example, an encoder and/or a hall sensor. Further, the angle sensors may obtain motion values of the leg driving frames of the wearable device 100. For example, the first angle sensor 524 may obtain a motion value of the first leg driving frame 55 and the second angle sensor 524-1 may obtain a motion value of the second leg driving frame 50. The motion values of the leg driving frames 50 and 55 may correspond to the hip joint angle values of the user.

In an embodiment, the sensor module 520 may further include at least one of a position sensor configured to obtain a position value of the wearable device 100, a proximity sensor configured to sense the proximity of an object, a biosignal sensor configured to detect a biosignal of the user, or a temperature sensor configured to measure an ambient temperature. The types of sensors that the sensor module 520 may include are not limited to the examples described above.

The input module 540 may receive a command or data to be used by another component (e.g., the processor 512) of the wearable device 100 from the outside (e.g., a user) of the wearable device 100. The input module 540 may include an input component circuit. The input module 540 may include, for example, a key (e.g., a button) or a touch screen.

The sound output module 550 may output a sound signal to the outside of the wearable device 100. The sound output module 550 may provide auditory feedback to the user. For example, the sound output module 550 may include a speaker configured to play back a guiding sound signal (e.g., an operation start sound, an operation error alarm, or an exercise start alarm), music content, or a guiding voice for auditorily informing predetermined information (e.g., exercise result information or exercise posture evaluation information).

The haptic module 560 may provide haptic feedback to the user under the control of the processor 512. The haptic module 560 may convert an electrical signal into a mechanical stimulus (e.g., a vibration or a movement) or an electrical stimulus which may be recognized by a user via his or her tactile sensation or kinesthetic sensation. The haptic module 560 may include a motor, a piezoelectric element, or an electrical stimulation device. In an embodiment, the haptic module 560 may be positioned in at least one of the base body (e.g., the base body 80) or the thigh fastening portion (e.g., the first thigh fastening portion 2 or the second thigh fastening portion 1).

In an embodiment, the control system 500 and 500-1 may include a battery (not shown) configured to supply power to each component of the wearable device 100 and a power management circuit (not shown) configured to convert power from the battery to an operating voltage of each component of the wearable device 100 and supply the same to each component.

The driving module 530 may generate an external force to be applied to a leg of the user under the control of the processor 512. The driving module 530 may generate torque to be applied to the legs of the user based on a control signal generated by the processor 512. The processor 512 may transmit the control signal to control an operation of the motor 534 to the motor driver circuit 532. The motor driver circuit 532 may control the operation of the motor 534 by generating a current signal (or voltage signal) corresponding to the control signal received from the processor 512 and supplying the generated current signal to the motor 534. Depending on the operation mode of the wearable device 100, a current signal may not be supplied to the motor 534. When the motor 534 is supplied with the current signal and is driven, the motor 534 may generate torque for an assistance force to assist leg motion of the user or for a resistance force to impede the leg motion of the user.

The processor 512 may execute, for example, software to control at least one other component (e.g., a hardware or software component) of the wearable device 100 connected to the processor 512, and may perform a variety of data processing or computation. For example, the processor 512 may generate a control signal to control each component (e.g., the communication module 516, the driving module 530, the sound output module 550, or the haptic module 560) of the wearable device 100. The software to be executed by the processor 512 may include an application for providing a GUI. According to an embodiment, as at least a part of data processing or computation, the processor 512 may store instructions or data received from another component (e.g., the communication module 516) in the memory 514, may process the instructions or the data stored in the memory 514, and may store result data in the memory 514. According to an embodiment, the processor 512 may include a main processor (e.g., a central processing unit (CPU) or an application processor (AP)) or an auxiliary processor (e.g., a graphics processing unit (GPU), a neural processing unit (NPU), an image signal processor (ISP), a sensor hub processor, or a communication processor (CP)) that is operable independently of or in conjunction with the main processor. The auxiliary processor may be implemented separately from the main processor or as a part of the main processor.

The memory 514 may store a variety of data used by at least one component (e.g., the processor 512) of the wearable device 100. The variety of data may include, for example, software, sensor data, and input data or output data for instructions related thereto. The memory 514 may include a volatile memory or a non-volatile memory (e.g., random-access memory (RAM), dynamic RAM (DRAM), or static RAM (SRAM)).

The communication module 516 may support establishing a direct (e.g., wired) communication channel or a wireless communication channel between the processor 512 and another component of the wearable device 100 or an external electronic device (e.g., the electronic device 210 or the other wearable devices 220 of FIG. 2), and performing communication via the established communication channel. The communication module 516 may include a communication circuit configured to perform a communication function. For example, the communication module 516 may receive a control signal from an electronic device (e.g., the electronic device 210) and transmit the sensor data obtained by the sensor module 520 to the electronic device. According to an embodiment, the communication module 516 may include one or more CPs (not shown) that are operable independently of the processor 512 and that support direct (e.g., wired) communication or wireless communication. According to an embodiment, the communication module 516 may include a wireless communication module (e.g., a cellular communication module, a short-range wireless communication module, or a global navigation satellite system (GNSS) communication module), and/or a wired communication module. A corresponding one of the above-described communication modules may communicate with another component of the wearable device 100 and/or the electronic device via a short-range communication network, such as Bluetooth™, Wi-Fi, or infrared data association (IrDA), or a long-range communication network, such as a legacy cellular network, a 5G network, a next-generation communication network, the Internet, or a computer network (e.g., a local area network (LAN) or a wide region network (WAN)).

The back electromotive force control circuit 570 may monitor and control a back electromotive force that may be generated according to the operation of the motor 534. In electrical components having inductance, such as the motor 534, a back electromotive force, which is an electromotive force that occurs in the opposite direction to the power supply voltage, may be generated. For example, when a user moves his or her legs while wearing the wearable device 100, causing a rotor of the motor 534 to rotate, a voltage corresponding to the back electromotive force may be generated in a three-phase winding of the motor 534. When an unintended large level of back electromotive force is generated, there may be a risk that the electrical components of the wearable device 100 through which the back electromotive force flows in or passes may be damaged or the wearable device 100 may operate abnormally. The back electromotive force control circuit 570 may monitor the back electromotive force and limit the voltage level of the back electromotive force when the voltage level of the back electromotive force exceeds a predetermined reference level. The electrical components of the wearable device 100 may be protected from the back electromotive force by the back electromotive force control circuit 570. In an embodiment, the back electromotive force control circuit 570 may include a clipping circuit configured to compare a voltage level (e.g., a voltage amplitude) of a back electromotive force with a reference level, and limit the voltage level of the back electromotive force to the reference level or lower when the voltage level of the back electromotive force exceeds the reference level. In an embodiment, the clipping circuit may limit the voltage level of the back electromotive force to within a predetermined range. The clipping circuit may include, for example, a comparator (e.g., an operational amplifier comparator (OP AMP)) configured to compare the voltage level of the back electromotive force with a reference level, and a switching element (e.g., a MOSFET) configured to determine whether to limit the voltage level of the back electromotive force based on an output signal of the comparator. Using the comparator, precise control of the voltage level of the back electromotive force may be possible without the occurrence of nonlinear sections that may occur in a scheme using a diode. In an embodiment, the term “voltage level of back electromotive force” may be replaced with “signal level of back electromotive force” or “current level of back electromotive force,” and the back electromotive force control circuit 570 may monitor and control a signal level or current level of the back electromotive force in the same manner as monitoring and controlling of the voltage level of the back electromotive force described in the embodiments of the present disclosure.

In an embodiment, the back electromotive force control circuit 570 may be connected to an input terminal of the motor driver circuit 532 and may monitor a back electromotive force that may be output from the motor driver circuit 532. The back electromotive force control circuit 570 may limit the voltage level of the back electromotive force to the reference level or lower. In the case of FIG. 5B, the control system 500-1 may further include a back electromotive force control circuit 570-1 configured to monitor and control the back electromotive force that may be generated according to an operation of the motor 534-1. The back electromotive force control circuit 570-1 may be connected to the input terminal of the motor driver circuit 532-1 and may control the back electromotive force that may be output from the motor driver circuit 532. The description of the back electromotive force control circuit 570 described below may also be applied to the back electromotive force control circuit 570-1 illustrated in FIG. 5B.

The wearable device 100 according to an embodiment may include the driving modules 530 and 530-1, which include the motors 534 and 534-1 and the motor driver circuits 532 and 532-1 controlling the motors 534 and 534-1 and are configured to generate torque applied to a body of a user using the motors 534 and 534-1 and the motor driver circuits 532 and 532-1, a waist support frame (e.g., the waist support frame 20 of FIG. 3) configured to support the body of the user when the wearable device 100 is worn on the body of the user, a leg driving frame (e.g., the leg driving frames 50 and 55 of FIG. 3) configured to relay the generated torque to the body of the user, the back electromotive force control circuits 570 and 570-1 configured to monitor a back electromotive force that may be generated according to an operation of the motors 534 and 534-1 and limit a voltage level of the back electromotive force to a reference level or lower, and the processor 512 configured to control an operation of the driving modules 530 and 530-1 and control the power supply to the back electromotive force control circuits 570 and 570-1.

In an embodiment, the wearable device 100 may be used as a portable device using a charged battery rather than being supplied with constant power from an external source, so the usage time may be limited depending on the amount of power in the battery. In order to increase the usage time of the wearable device 100, there may be a need to efficiently manage the amount of power used by each component of the wearable device 100. The processor 512 may reduce power (or current) unnecessarily consumed in the back electromotive force control circuits 570 and 570-1 by controlling the power supply of the back electromotive force control circuits 570 and 570-1 based on an operation mode of the wearable device 100 and/or a state of the driving modules 530 and 530-1. The processor 512 may optimize the power usage of the back electromotive force control circuits 570 and 570-1. The processor 512 may distinguish when an operation of the back electromotive force control circuits 570 and 570-1 is required, and may block the power supply to the back electromotive force control circuits 570 and 570-1 when the operation of the back electromotive force control circuits 570 and 570-1 is not required. In an embodiment, the processor 512 may control to supply power to the back electromotive force control circuits 570 and 570-1 when a scenario in which the function of the motors 534 and 534-1 operates is executed on a user interface of the electronic device 210, and may block the power supply to the back electromotive force control circuits 570 and 570-1 when a scenario in which the function of the motors 534 and 534-1 does not operate is executed. In an embodiment, the processor 512 may automatically detect an operation of the motors 534 and 534-1 to determine whether to supply power to the back electromotive force control circuits 570 and 570-1.

In an embodiment, when the processor 512 receives a control signal indicating a driving command of the wearable device 100 from the electronic device 210, the processor 512 may control the power to be supplied to the back electromotive force control circuits 570 and 570-1 in response to receiving the control signal. Here, the driving command may be a driving command that requires an operation of the motors 534 and 534-1.

In an embodiment, the processor 512 may control the power to be supplied to the back electromotive force control circuits 570 and 570-1 when an operation mode (e.g., an exercise assistance mode or a walking assistance mode) of the wearable device 100 that requires the power supply to the motors 534 and 534-1 is executed. The processor 512 may control the power supply to the back electromotive force control circuits 570 and 570-1 to be blocked when an operation mode (e.g., an exercise posture evaluation mode or a standby mode) of the wearable device 100 in which power is not supplied to the motors 534 and 534-1 is executed.

In an embodiment, the processor 512 may determine whether to supply power to the back electromotive force control circuits 570 and 570-1 depending on whether power is supplied to the motors 534 and 534-1. For example, when power is supplied to the motors 534 and 534-1, the processor 512 may determine to supply power to the back electromotive force control circuits 570 and 570-1. When power is not supplied to the motors 534 and 534-1, the processor 512 may determine to block the power supply to the back electromotive force control circuits 570 and 570-1.

In an embodiment, the processor 512 may determine whether to supply power to the back electromotive force control circuits 570 and 570-1 depending on whether power is supplied to the motor driver circuits 532 and 532-1. For example, when power is not supplied to the motor driver circuits 532 and 532-1, the processor 512 may control the power supply to the back electromotive force control circuits 570 and 570-1 to be blocked. When power is supplied to the motor driver circuits 532 and 532-1 and power is supplied from the motor driver circuits 532 and 532-1 to the motors 534 and 534-1, the processor 512 may control the power to be supplied to the back electromotive force control circuits 570 and 570-1.

In an embodiment, when movement of the motors 534 and 534-1 is detected and a motor rotation sensor configured to detect the rotation of the motors 534 and 534-1 around a rotor of the motors 534 and 534-1 is not operating, the processor 512 may control the power supply to the back electromotive force control circuits 570 and 570-1 to be blocked. For example, the motor rotation sensor may include a hall sensor. When movement of the motors 534 and 534-1 is detected and the angle sensors 524 and 524-1 configured to measure an angle of the leg driving frame is not operating, the processor 512 may control the power supply to the back electromotive force control circuits 570 and 570-1 to be blocked. When movement of the motors 534 and 534-1 is detected, and at least one of the motor rotation sensor configured to detect the rotation of the motors 534 and 534-1 around the rotor of the motors 534 and 534-1 or the angle sensors 524 and 524-1 configured to measure an angle of the leg driving frame is operating, and power is supplied to the motors 534 and 534-1, the processor 512 may control the power to be supplied to the back electromotive force control circuits 570 and 570-1.

The processor 512 may reduce the overall power consumption of the wearable device 100 and increase the usage time by optimizing the power usage of the back electromotive force control circuits 570 and 570-1 as described above. By increasing the usage time of the wearable device 100, product competitiveness may be improved and customer satisfaction may be increased.

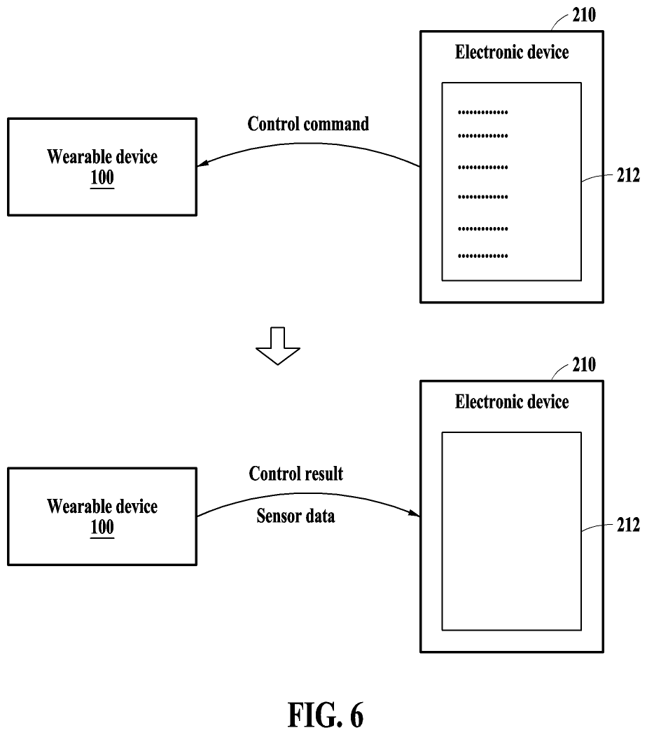

FIG. 6 is a diagram illustrating an interaction between a wearable device and an electronic device, according to an embodiment.

Referring to FIG. 6, the wearable device 100 may communicate with the electronic device 210. For example, the electronic device 210 may be a user terminal of a user using the wearable device 100 or a controller device dedicated to the wearable device 100. In an embodiment, the wearable device 100 and the electronic device 210 may be connected to each other through short-range wireless communication (e.g., Bluetooth™ or Wi-Fi communication).

In an embodiment, the electronic device 210 may check the state of the wearable device 100 or execute an application to control or operate the wearable device 100. A screen of a user interface (UI) may be displayed to control an operation of the wearable device 100 or determine an operation mode of the wearable device 100 on a display 212 of the electronic device 210 through the execution of the application. The UI may be, for example, a GUI.

In an embodiment, a user may input a command (e.g., a command to execute a walking assistance mode, an exercise assistance mode, or a physical ability measurement mode) to control the operation of the wearable device 100 or may change the setting of the wearable device 100 through a GUI screen on the display 212 of the electronic device 210. The electronic device 210 may generate a control command (or a control signal) corresponding to an operation control command or setting change command input by the user and may transmit the generated control command to the wearable device 100. The wearable device 100 may operate according to the received control command and may transmit a control result according to the received control command and/or sensor data sensed by a sensor module of the wearable device 100 to the electronic device 210. The electronic device 210 may provide the user with result information (e.g., gait ability information, exercise ability information, or exercise posture evaluation information) derived by analyzing the control result and/or the sensor data through the GUI screen.

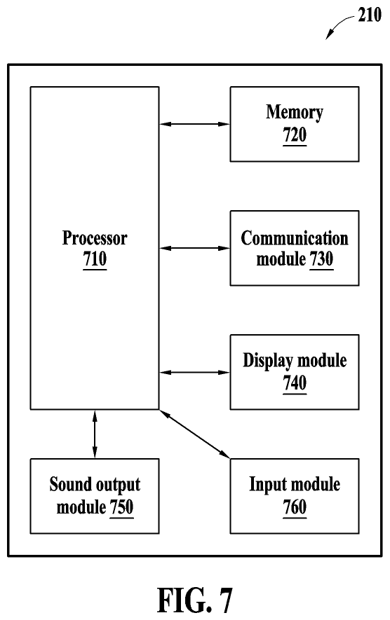

FIG. 7 is a diagram illustrating a configuration of an electronic device according to an embodiment.

Referring to FIG. 7, the electronic device 210 may include a processor 710, a memory 720, a communication module 730, a display module 740, a sound output module 750, and an input module 760. In an embodiment, at least one of the components (e.g., the sound output module 750) may be omitted from the electronic device 210, or one or more other components (e.g., a sensor module, a haptic module, and a battery) may be added to the electronic device 210.

The processor 710 may control at least one other component (e.g., a hardware or software component) of the electronic device 210 and may perform various types of data processing or operations. In an embodiment, as at least a part of data processing or operations, the processor 710 may store instructions or data received from another component (e.g., the communication module 730) in the memory 720, process the instructions or the data stored in the memory 720, and store result data in the memory 720.

In an embodiment, the processor 710 may include a main processor (e.g., a CPU or an AP) or an auxiliary processor (e.g., a GPU, an NPU, an ISP, a sensor hub processor, or a CP) that is operable independently of or in conjunction with the main processor.

The memory 720 may store various pieces of data used by at least one component (e.g., the processor 710 or the communication module 730) of the electronic device 210. The data may include, for example, a program (e.g., an application), and input data or output data for a command related thereto. The memory 720 may include at least one instruction executable by the processor 710. The memory 720 may include, for example, a volatile memory or a non-volatile memory.

The communication module 730 may support establishing a direct (e.g., wired) communication channel or a wireless communication channel between the electronic device 210 and another electronic device (e.g., the wearable device 100, the other wearable device 220, or the server 230) and performing communication via the established communication channel. The communication module 730 may include a communication circuit for performing a communication function. The communication module 730 may include one or more CPs that are operable independently of the processor 710 (e.g., an AP) and that support direct (e.g., wired) communication or wireless communication. In an embodiment, the communication module 730 may include a wireless communication module (e.g., a Bluetooth™ communication module, a cellular communication module, a Wi-Fi communication module, or a GNSS communication module) that performs wireless communication or a wired communication module (e.g., a LAN communication module or a power line communication (PLC) module). For example, the communication module 730 may transmit a control command to the wearable device 100 and may receive, from the wearable device 100, at least one of sensor data including body motion information of a user wearing the wearable device 100, state data of the wearable device 100, or control result data corresponding to the control command.

The display module 740 may visually provide information to the outside (e.g., the user) of the electronic device 210. The display module 740 may include, for example, a liquid-crystal display (LCD) or organic light-emitting diode (OLED) display, a hologram device, or a projector device. The display module 740 may further include a control circuit to control the driving of the display. In an embodiment, the display module 740 may include a touch sensor adapted to sense a touch, or a pressure sensor adapted to measure an intensity of a force incurred by the touch. The display module 740 may output a UI screen to control the wearable device 100 or provide various pieces of information (e.g., exercise evaluation information or setting information of the wearable device 100).

The sound output module 750 may output a sound signal to the outside of the electronic device 210. The sound output module 750 may include a speaker configured to play back a guiding sound signal (e.g., an operation start sound or an operation error alarm), music content, or a guiding voice based on the state of the wearable device 100. For example, when it is determined that the wearable device 100 is not properly worn on the body of the user, the sound output module 750 may output a guiding voice to inform the user they are wearing the wearable device 100 abnormally or to guide the user to wear the wearable device 100 normally. The sound output module 750 may output, for example, a guiding voice corresponding to exercise evaluation information or exercise result information obtained by evaluating an exercise of the user.

The input module 760 may receive a command or data to be used by another component (e.g., the processor 710) of the electronic device 210, from the outside (e.g., the user) of the electronic device 210. The input module 760 may include an input component circuit and receive a user input. The input module 760 may include, for example, a touch recognition circuit for recognizing a touch on a key (e.g., a button) and/or a screen.

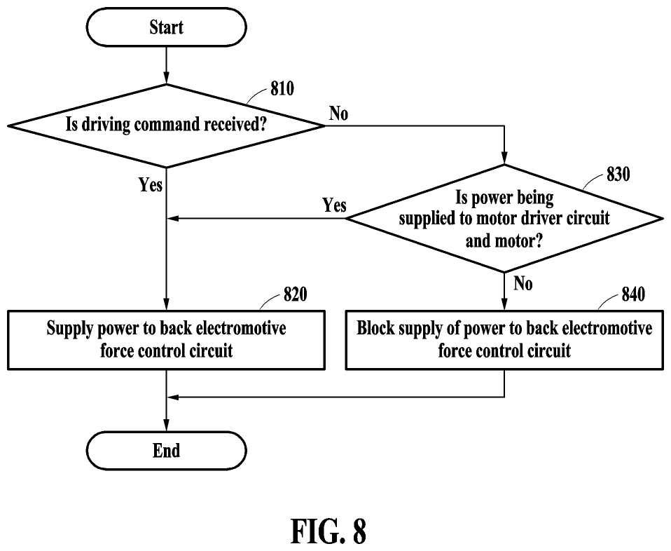

FIG. 8 is a flowchart illustrating a method of controlling a back electromotive force control circuit of a wearable device, according to an embodiment. In an embodiment, at least one of the operations of FIG. 8 may be simultaneously or parallelly performed with one another, and the order of the operations may be changed. In addition, at least one of the operations may be omitted, or another operation may be additionally performed.

Referring to FIG. 8, in operation 810, the wearable device 100 may determine whether a driving command for using the wearable device 100 is received from the electronic device 210 that is linked with the wearable device 100. For example, when a user inputs a user input for a command to start exercise on a UI provided through the electronic device 210, a driving command for driving into an exercise assistance mode may be transmitted from the electronic device 210 to the wearable device 100. The driving command may cause power to be supplied to a motor (e.g., the motors 534 and 534-1) included in the wearable device 100 to operate the motor.

When the wearable device 100 receives a driving command (when “yes” in operation 810), the wearable device 100 may control the power to be supplied to a back electromotive force control circuit (e.g., the back electromotive force control circuits 570 and 570-1) in operation 820, in response to receiving the driving command from the electronic device 210. For example, when the exercise assistance mode of the wearable device 100 is performed, the wearable device 100 may supply power to the back electromotive force control circuit to activate the back electromotive force control circuit. When power is supplied to the back electromotive force control circuit, monitoring of the back electromotive force that may be generated from the motor and clipping of the voltage level of the back electromotive force may be performed. When the back electromotive force control circuit is supplied with power and activated, the voltage level of the back electromotive force generated from the motor may be limited to a reference level or lower.

When the wearable device 100 does not receive a driving command (when “no” in operation 810), in operation 830, the wearable device 100 may determine whether power is being supplied to a motor driver circuit (e.g., the motor driver circuits 532 and 532-1) and the motor while not receiving the driving command. The wearable device 100 may control the power supply to the back electromotive force control circuit based on whether power is supplied to the motor driver circuit that determines whether the motor may operate and whether power is supplied to the motor.

When power is being supplied to both the motor driver circuit and the motor (when “yes” in operation 830), the wearable device 100 may control the power to be supplied to the back electromotive force control circuit (e.g., the back electromotive force control circuits 570 and 570-1) in operation 820. In at least one of a state in which power is not supplied to the motor driver circuit or a state in which power is not supplied to the motor (when “no” in operation 830), the wearable device 100 may control the power supply to the back electromotive force control circuit to be blocked in operation 840.

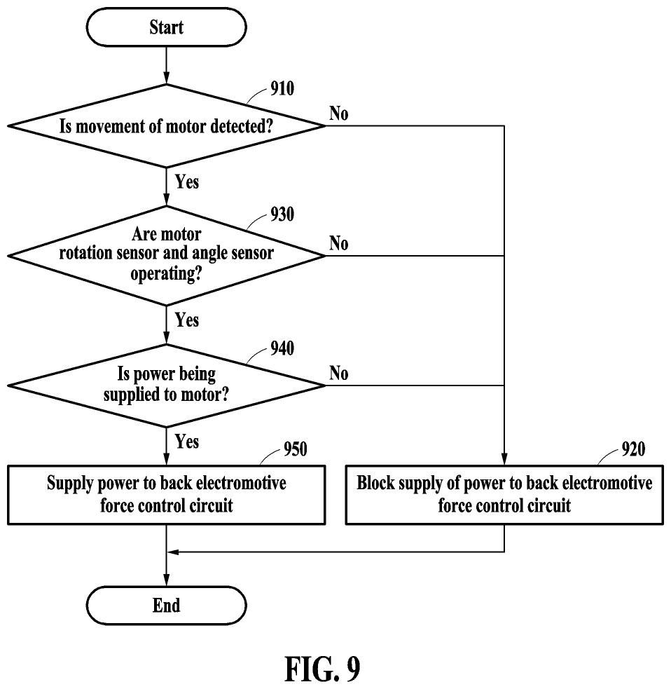

FIG. 9 is a flowchart illustrating a method of controlling a back electromotive force control circuit of a wearable device, according to an embodiment. In an embodiment, at least one of the operations of FIG. 9 may be simultaneously or parallelly performed with one another, and the order of the operations may be changed. In addition, at least one of the operations may be omitted, or another operation may be additionally performed.

Referring to FIG. 9, in operation 910, the wearable device 100 may detect whether there is a movement of a motor (e.g., the motors 534 and 534-1). The wearable device 100 may automatically detect an operation of the motor and determine whether to supply power to a back electromotive force control circuit (e.g., the back electromotive force control circuits 570 and 570-1). When a movement of the motor is not detected (when “no” in operation 910), the wearable device 100 may control the power supply to the back electromotive force control circuit to be blocked in operation 920.

When a movement of the motor is detected (when “yes” in operation 910), the wearable device 100 may determine whether a motor rotation sensor configured to detect the rotation of the motor around a rotor of the motor and an angle sensor configured to measure an angle of a leg driving frame (e.g., the leg driving frames 50 and 55) are operating in operation 930. The wearable device 100 may determine whether to block the power supply to the back electromotive force control circuit based on whether the motor rotation sensor or angle sensor is operating. For example, when a movement of the motor is detected and the motor rotation sensor is not operating, the wearable device 100 may control the power supply to the back electromotive force control circuit to be blocked in operation 920. When a movement of the motor is detected and the angle sensor is not operating, the wearable device 100 may control the power supply to the back electromotive force control circuit to be blocked in operation 920. “Based on” as used herein covers based at least on.

When the motor rotation sensor and angle sensor are operating (when “yes” in operation 930), the wearable device 100 may determine whether power is being supplied to the motor in operation 940. When a movement of the motor is detected, at least one of the motor rotation sensor or the angle sensor is operating, and power is supplied to the motor (when “yes” in operation 940), the wearable device 100 may control the power to be supplied to the back electromotive force control circuit in operation 950. When power is not being supplied to the motor (when “no” in operation 940), the wearable device 100 may control the power supply to the back electromotive force control circuit to be blocked in operation 920.

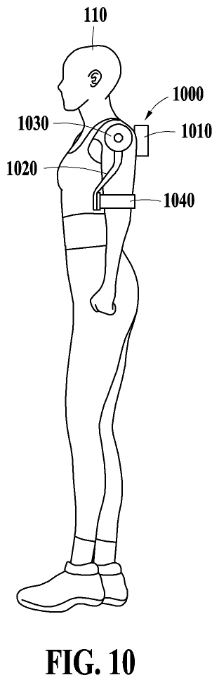

FIG. 10 is a diagram illustrating a wearable device worn on a user's upper arm, according to an embodiment.

Referring to FIG. 10, a wearable device 1000 worn on an upper arm of the user 110 may include a base body 1010, a driving frame 1020, a driving module 1030, and a fastening portion 1040. In an embodiment, at least one of the components described above may be omitted from the wearable device 1000 or one or more other components may be added to the wearable device 1000. In an embodiment, a driving module 1030 including a motor (not shown) for generating torque and a motor driver circuit (not shown) for controlling a motor may be provided near the shoulder joint. The driving frame 1020, or an angle sensor (not shown) for measuring a joint angle of the upper arm of the user 110 may be provided around the motor of the driving module 1030. The driving frame 1020 may be disposed along the upper arm of the user 110 and may be connected, directly or indirectly, to the fastening portion 1040. The fastening portion 1040 may secure the wearable device 1000 to the upper arm of the user and support a portion of the upper arm of the user. Components for a control system of the wearable device 1000 may be provided inside the base body 1010. The control system may include a processor (not shown), a memory (not shown), a communication module (not shown) comprising communication circuitry, an IMU (not shown), and a battery for controlling each component of the wearable device 1000. In an embodiment, the base body 1010 may be positioned on a portion of the user's back while the user 110 is wearing the wearable device 1000. The base body 1010 may provide a cushioning feeling to the user's 110 back and support the user's back together with a shoulder support frame (not shown). In addition, the functions and operations of each component of the wearable device 1000 may be applied to the functions and operations of the corresponding components described with reference to FIGS. 3, 4, 5A, and 5B.

In an embodiment, the wearable device 1000 may further include a back electromotive force control circuit (not shown) configured to monitor and control a back electromotive force that may be generated according to an operation of the motor. The processor may control the power supply to the back electromotive force control circuit. The processor may optimize the power usage of the back electromotive force control circuit by supplying power to or blocking the power supply to the back electromotive force control circuit depending on an operation mode of the wearable device 1000 and/or an operation state of the motor. Regarding the controlling of the power supply to the back electromotive force control circuit by the processor, the operations of the processor 512 described in FIGS. 5A and 5B may be referred to, any repeated description related thereto may be omitted.

It should be appreciated that various embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via a third element. Thus, for example, “connected” as used herein covers both direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC). Thus, each “module” herein may comprise circuitry.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums. Embodiments as set forth herein may be implemented as software including one or more instructions that are stored in a storage medium (e.g., the memory 514) that is readable by a machine. For example, a processor of the machine may invoke at least one of the one or more instructions stored in the storage medium and execute it. This allows the machine to be operated to perform at least one function according to the at least one instruction invoked. The one or more instructions may include code generated by a compiler or code executable by an interpreter. The machine- readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A wearable device, comprising:
a driving module, comprising a motor and a motor driver circuit, configured to generate torque to be applied to a body of a user;
a waist support frame configured to support at least part of the body of the user;
a leg driving frame configured to relay at least part of the generated torque to the body of the user;
a back electromotive force control circuit configured to monitor a back electromotive force generated according to an operation of the motor and limit a voltage level of the back electromotive force to a reference level and/or lower; and
at least one processor, comprising processing circuitry, individually and/or collectively configured to control an operation of the driving module and control power supply to the back electromotive force control circuit.

2. The wearable device of claim 1, wherein the at least one processor is individually and/or collectively configured to:
in response to an operation mode of the wearable device with power supply to the motor being executed, control power to be supplied to the back electromotive force control circuit; and
in response to an operation mode of the wearable device in which power is not supplied to the motor being executed, control power supply to the back electromotive force control circuit to be blocked.

3. The wearable device of claim 1, wherein the at least one processor is individually and/or collectively configured to:
in response to power being supplied to the motor, determine to supply power to the back electromotive force control circuit; and
in response to power not being supplied to the motor, determine to block power supply to the back electromotive force control circuit.

4. The wearable device of claim 1, wherein the at least one processor is individually and/or collectively configured to:
in response to receiving a control signal indicating a driving command of the wearable device from an electronic device, control power to be supplied to the back electromotive force control circuit.

5. The wearable device of claim 1, wherein the at least one processor is individually and/or collectively configured to:
in a state in which power is not supplied to the motor driver circuit, control power supply to the back electromotive force control circuit to be blocked.

6. The wearable device of claim 1, wherein the at least one processor is individually and/or collectively configured to:
in a state in which power is supplied to the motor driver circuit and power is supplied from the motor driver circuit to the motor, control power to be supplied to the back electromotive force control circuit.

7. The wearable device of claim 1, wherein the at least one processor is individually and/or collectively configured to:
in a state in which a movement of the motor is detected and a motor rotation sensor configured to detect a rotation of the motor around a rotor of the motor is not operating, control power supply to the back electromotive force control circuit to be blocked.

8. The wearable device of claim 1, wherein the at least one processor is individually and/or collectively configured to:
in a state in which a movement of the motor is detected and an angle sensor configured to measure an angle of the leg driving frame is not operating, control power supply to the back electromotive force control circuit to be blocked.

9. The wearable device of claim 1, wherein the at least one processor is individually and/or collectively configured to:
in a state in which a movement of the motor is detected, at least one of the motor rotation sensor configured to detect the rotation of the motor around the rotor of the motor and/or the angle sensor configured to measure the angle of the leg driving frame is operating, and power is supplied to the motor, control power to be supplied to the back electromotive force control circuit.

10. A method of controlling a back electromotive force control circuit of a wearable device, which comprises a motor, a motor driver circuit configured to control the motor, and a back electromotive force control circuit configured to monitor a back electromotive force to be generated according to an operation of the motor and limit a voltage level of the back electromotive force to a reference level and/or lower, the method comprising:
determining whether a driving command for the wearable device is received from an electronic device that is linked with the wearable device;
determining whether power is being supplied to the motor driver circuit and the motor in a state in which the driving command is not received; and
controlling power supply to the back electromotive force control circuit based on whether power is supplied to the motor driver circuit and whether power is supplied to the motor.

11. The method of claim 10, further comprising:
controlling power to be supplied to the back electromotive force control circuit in response to receiving the driving command from the electronic device 210.

12. The method of claim 10, wherein the controlling of the power supply to the back electromotive force control circuit comprises
controlling power supply to the back electromotive force control circuit to be blocked in at least one of a state in which power is not supplied to the motor driver circuit or a state in which power is not supplied to the motor.

13. A method of controlling a back electromotive force control circuit of a wearable device, which comprises a motor, a motor driver circuit configured to control the motor, a leg driving frame configured to relay torque generated by the motor to a body of a user, and the back electromotive force control circuit configured to monitor a back electromotive force generated according to an operation of the motor and limit a voltage level of the back electromotive force to a reference level and/or lower, the method comprising:
detecting whether there is a movement of the motor;
in response to a movement of the motor being detected, determining whether a motor rotation sensor configured to detect a rotation of the motor and an angle sensor configured to measure an angle of the leg driving frame are operating; and
determining whether to block power supply to the back electromotive force control circuit based on whether the motor rotation sensor and/or the angle sensor is operating.

14. The method of claim 13, wherein the determining of whether to block the power supply to the back electromotive force control circuit comprises
controlling power supply to the back electromotive force control circuit to be blocked in a state in which the movement of the motor is detected and at least one of the motor rotation sensor and the angle sensor is not operating.

15. The method of claim 13, wherein the determining of whether to block the power supply to the back electromotive force control circuit comprises
controlling power to be supplied to the back electromotive force control circuit in a state in which the movement of the motor is detected, at least one of the motor rotation sensor or the angle sensor is operating, and power is supplied to the motor.
